(19) United States
(12) Patent Application Publication
(10) Pub. No.: US 2019/0101227 A1
(43) Pub. Date: Apr. 4, 2019

(54) Tap Securing Device

(71) Applicant: RP2 Global Limited, Chelmsford (GB)

(72) Inventor: Nick Cooney, Chelmsford (GB)

(21) Appl. No.: 16/148,254

(22) Filed: Oct. 1, 2018

(30) Foreign Application Priority Data
Oct. 2, 2017 (GB) 1715945.0

(51) Int. Cl. F16K 35/06

(52) U.S. Cl. CPC F16K 35/06

(57) ABSTRACT

A tap securing device comprising an elongate structure formed by a plurality of interconnected rings. The elongate structure further comprises first and second arms, the first arm located at a first end of the elongate structure and the second arm located at a second end of the elongate structure. The elongate structure is formed from a flexible resilient plastics material as a unitary moulding. Device is used to secure elements of a tap relative to each other and so prevent adjustment of the tap. This ensures the tap cannot be operated inadvertently by children.

### FIELD OF THE INVENTION

This invention relates to a tap securing device for use in relation to kitchen and bathroom taps and faucets.

### BACKGROUND TO THE INVENTION

In the household, children can often operate a tap without an adult being aware, leading to floods within the home. Children can inadvertently adjust a tap whilst in a bath to cause hot water to come out of the tap, leading to scalding and other injuries.

It is an aim of the present invention to provide a device for securing taps so as to avoid inadvertent operation of taps by a child.

### SUMMARY OF THE INVENTION

In accordance with the present invention, there is provided a tap securing device comprising an elongate structure formed by a plurality of interconnected rings. Such a device can be looped or tied around taps and faucets to prevent inadvertent operation of the tap or adjustment of the temperature of water flowing out of the tap. This ensures that children cannot operate the tap on their own, preventing flooding from overfilling of sinks and baths and preventing injuries such as scalds from too hot water.

The elongate structure is preferably formed by a single row of interconnected rings, such that the rings extend along a linear axis, each ring being connected to the next adjacent ring to create a chain of rings. By having an elongate structure formed by interconnected rings, the device is adjustable for different tap configurations and so can be used with lever operated taps, rotatable taps, crosshead taps and roundhead taps.

The elongate structure may further comprise first and second arms, the first arm located at a first end of the elongate structure and the second arm located at a second end of the elongate structure. By having one arm located at each end of the elongate structure, the arms can be inserted into one or more of the rings so as to secure the device in position around a tap.

Preferably the first and second arms extend substantially orthogonal to the row of interconnected rings, being in substantially the same plane. This ensures the arms can be inserted into the rings to form the elongate structure into a closed loop.

The rings may be formed in a substantially oval shape and preferably each ring within the elongate structure is identical. When oval rings are used, they are preferably connected together in succession along a major axis of each ring so as to form the elongate structure.

The elongate structure is preferably formed from a flexible and/or resilient material, and is typically formed from a plastics material such as silicone, and desirably as a unitary moulding. Preferably the elongate structure is made from a mould resistant material and preferably a waterproof material.

### BRIEF DESCRIPTION OF THE DRAWINGS

The invention will now be described, by way of example, with reference to the accompanying drawings in which:

FIG. 1 is a plan view of the tap securing device; and

FIGS. 2 to 7 show various types of taps secured by the aforementioned device.

### DESCRIPTION

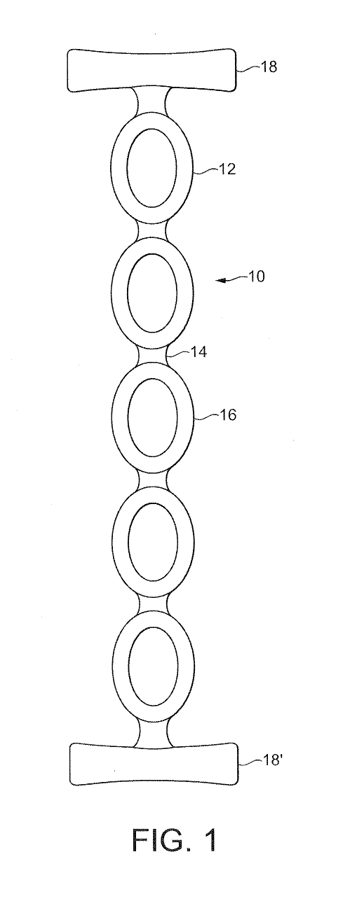

Tap securing device 10 shown in FIG. 1 comprises a series of oval rings 12 connected linearly along their major or longest axis at connection points 14 so as to form an elongate structure or chain 16 having five rings. Substantially cylindrical arms 18, 18′ are each connected to one end of the single row of connected rings 12. Arms 18, 18′ can be inserted into rings 12 to form a closed loop with variation in the length of the loop achievable depending on which ring an arm is inserted into. As will be appreciated, the number and dimensions of the individual rings can be varied although at least two rings will be required.

Typically device 10 is formed as a unitary moulding from waterproof plastics material such as silicone treated to ensure it is mould resistant. The plastics material is flexible and resilient allowing device 10 to be stretched and used under tension to help secure elements of a tap relative to each other, so preventing a child from adjusting a tap. Device 10 is suitable for use with a variety of different types of taps or faucet such as taps that are rotatable by either quarter or full turn operation or taps that move by operation of a lever in either a vertical or horizontal plane. As such, device 10 is suitable for at least crosshead taps, lever taps, and roundhead taps.

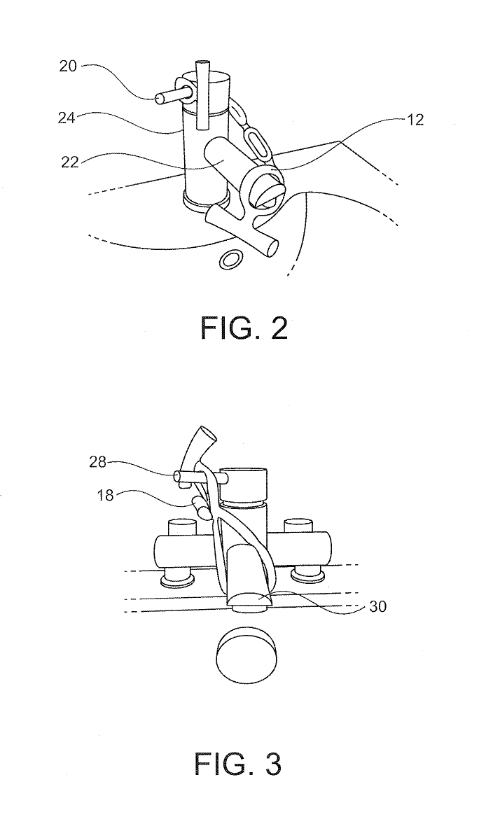

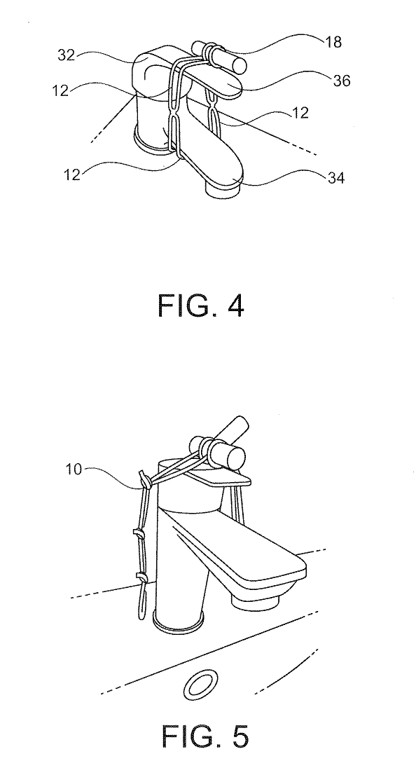

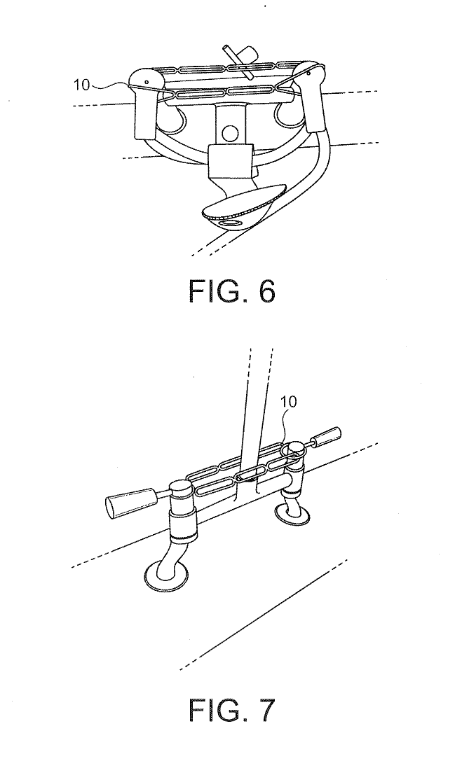

FIGS. 2 to 7 illustrate use of device 10 with a variety of different types of tap. FIG. 2 shows an arrangement where rings 12 are positioned around spaced apart portions 20, 22 of single mixer tap 24 so as to prevent operation of or adjustment of the tap. In FIG. 3, moveable lever 28 is fixed in position by arm 18 locating within one ring to form a loop around fixed tap outlet 30 and another ring locating around moveable lever 28. Alternatively device 10 can be used in relation to lever tap 32 by positioning one or more of arms 18, 18′ within one or more rings 12 to form device 10 into a closed loop around fixed portion 34 and moveable lever 36 and so prevent movement of lever 36, see FIG. 4. Other arrangements are shown in FIGS. 5 to 7 with device 10 being easy to secure in position.

By having a plurality of rings 12, device 10 can be used with a wide variety of differently shaped and dimensioned taps and where device 10 is formed from a resilient material, the device can readily be placed under tension to make the device more difficult to remove. The provision of arms 18, 18′ allows for versatility in manner of attachment as rings 12 can be used to locate over portions of a tap, and/or device 10 looped around a tap and secured to itself by locating at least one of arms 18, 18′ within one of the rings 12. Device 10 is readily releasable for an adult and so easily removed and replaced as needed, whilst being extremely difficult for a child to disconnect and so an adult can be reassured that taps are not moveable from the position in which they are secured by device 10.

What is claimed is:

1. A tap securing device comprising an elongate structure formed by a plurality of interconnected rings.

2. A tap securing device according to claim 1, wherein the elongate structure is formed by a single row of interconnected rings.

3. A tap securing device according to claim 2, wherein the elongate structure further comprises first and second arms, the first arm located at a first end of the elongate structure and the second arm located at a second end of the elongate structure.

4. A tap securing device according to claim 3, wherein the first and second arms extend substantially orthogonal to the row of interconnected rings.

5. A tap securing device according to claim 1, wherein the rings are formed in a substantially oval shape.

6. A tap securing device according to claim 1, wherein the elongate structure is formed from a flexible material.

7. A tap securing device according to claim 1, wherein the elongate structure is formed from a resilient material.

8. A tap securing device according to claim 1, wherein the elongate structure is formed from a mould resistant material.

9. A tap securing device according to claim 1, wherein the elongate structure is formed from a waterproof material.

10. A tap securing device according to claim 1, wherein the elongate structure is formed from a plastics material as a unitary moulding.
